(19) United States
(12) Patent Application Publication
(10) Pub. No.: US 2019/0120308 A1
(43) Pub. Date: Apr. 25, 2019

(54) ANTI-RATTLE SPRING FOR BRAKE CALIPER ASSEMBLY

(71) Applicant: HB Performance Systems, Inc., Mequon, WI (US)

(72) Inventors: Rodney Weekley, Mequon, WI (US); Steven Scheibe, Mequon, WI (US); Nicholas Uselmann, Mequon, WI (US); Timothy Osterberg, Mequon, WI (US); Robert Dennert, Mequon, WI (US)

(21) Appl. No.: 15/787,934

(22) Filed: Oct. 19, 2017

(51) Int. Cl. F16D 65/097; F16D 65/00; F16D 55/2265

(52) U.S. Cl. CPC F16D 65/0977; F16D 55/2265; F16D 65/0075

(57) ABSTRACT

A brake caliper assembly comprises a caliper housing having a central bridge, a pad assembly positioned in the caliper housing, and an anti-rattle spring. The anti-rattle spring includes a front section, a rear section, and a central section between the front and rear sections. The central section of the spring is biased toward the pad assembly by the bridge, and the central section is attached to the bridge (e.g., by a spring clip having resilient fingers) such that the spring stays attached to the bridge when the pad assembly is removed from the caliper housing. Preferably, the front and rear sections contact front and rear portions of the pad assembly, respectively, to provide a net bias on the pad assembly toward a torque take-out surface. The anti-rattle spring can further include an alignment feature that insures proper orientation of the anti-rattle spring relative to the caliper housing.

### BACKGROUND

The present invention relates generally to disc brake systems and specifically to springs for holding disc brake pads in position and preventing rattling.

Disc brake systems for vehicles commonly include a rotor secured for rotation with a vehicle wheel (or other traction member, such as a track on a snowmobile) and a caliper assembly secured to the vehicle frame. The caliper assembly commonly includes a caliper housing and two brake pads positioned on opposing side of the rotor. The pads are typically moved toward the rotor by one or more pistons.

In order to facilitate movement of the pads relative to the rotor, the pads are commonly loosely held in the caliper housing. For example, in one arrangement, the pads are mounted to slide on rails secured to the caliper housing. Because of this loose support, the pads have a tendency to rattle relative to the housing, and this rattling is alleviated be the provisions of anti-rattle springs between the caliper housing and the pads.

### SUMMARY

The present invention provides a brake caliper assembly comprising a caliper housing, a pad assembly positioned in the caliper housing, and an anti-rattle spring. The caliper housing includes an outer housing portion, an inner housing portion, a recess adapted to receive a brake disc between the outer housing portion and the inner housing portion, a torque take-out surface, and a bridge (e.g., between the inner and outer housing portions) substantially aligned with the recess. The pad assembly is positioned adjacent the recess and is adapted to contact the torque take-out surface. The anti-rattle spring includes a front section biasing the pad assembly, a rear section biasing the pad assembly, and a central section between the front and rear sections. The central section of the spring is biased toward the pad assembly by the bridge of the caliper housing, and the central section is attached to the bridge such that the spring stays attached to the bridge when the pad assembly is removed from the caliper housing. For example, the anti-rattle spring can be attached to the bridge by a spring clip (e.g., having resilient fingers engaging opposing notched surfaces of the bridge) that facilitates removable attachment of the anti-rattle spring to the bridge.

In one embodiment, the pad assembly comprises an inner pad assembly positioned in the inner housing portion, and the torque take-out surface comprises an inner torque take-out surface defined in the inner housing portion. In this embodiment, the brake caliper assembly can further include an outer pad assembly positioned in the outer housing portion, and an outer torque take-out surface defined in the outer housing portion and adapted to contact the outer pad assembly. Each of the inner and outer pad assemblies includes a front portion and a rear portion that are biased by the front section and rear section of the spring, respectively. Preferably, the front and rear sections contact the front and rear portions of the pad assembly, respectively, to provide a net bias of the pad assembly toward the torque take-out surface. For example, the anti-rattle spring can bias the front portions of the inner and outer pad assemblies in a forward direction such that the inner and outer pad assemblies contact the inner and outer torque take-out surfaces, respectively. The anti-rattle spring can bias the rear portions of the inner and outer pad assemblies in a direction substantially parallel to the torque take-out surfaces.

The rear section of the anti-rattle spring can comprise a neck portion positioned between and not engaged with the rear portions of the inner and outer pad assemblies, and a head portion engaged with the rear portions of the inner and outer pad assemblies. The front section of the anti-rattle spring can include a slot substantially parallel to the recess and dividing the front section of the anti-rattle spring into inner and outer parts that separately engage the inner and outer pad assemblies, respectively. Preferably, the inner and outer parts are cantilevered to provide at least partially independent forces on the inner and outer pad assemblies, respectively. The slot has a length that is preferably 40%-50% (e.g., about 45%) of the overall length of the anti-rattle spring.

The anti-rattle spring can further include an alignment feature that insures proper orientation of the anti-rattle spring relative to the caliper housing. For example, the alignment feature can comprise an asymmetrical tab adapted to fit into an asymmetrical space in the caliper housing.

Other aspects of the invention will become apparent by consideration of the detailed description and accompanying drawings.

### BRIEF DESCRIPTION OF THE DRAWINGS

FIG. 1 illustrates a brake assembly embodying the present invention.

FIG. 2 is an exploded view of the brake assembly shown in FIG. 1.

FIG. 3 is a perspective view of a portion of a brake caliper from the brake assembly shown in FIG. 1 with half of the housing removed.

FIG. 4 is a side view of the portion of the brake caliper shown in FIG. 3 with half of the housing and one of the pad assemblies removed.

FIG. 5 is a perspective view of an anti-rattle spring used in the brake caliper of FIG. 3.

FIG. 6 is a top view of the anti-rattle spring of FIG. 5.

FIG. 7 is a side view of the anti-rattle spring of FIG. 5.

FIG. 8 is a bottom view of the anti-rattle spring positioned in the housing.

FIG. 9 is a perspective view of an anti-rattle spring that is a second embodiment of present invention.

FIG. 10 is a top view of anti-rattle spring of FIG. 9.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

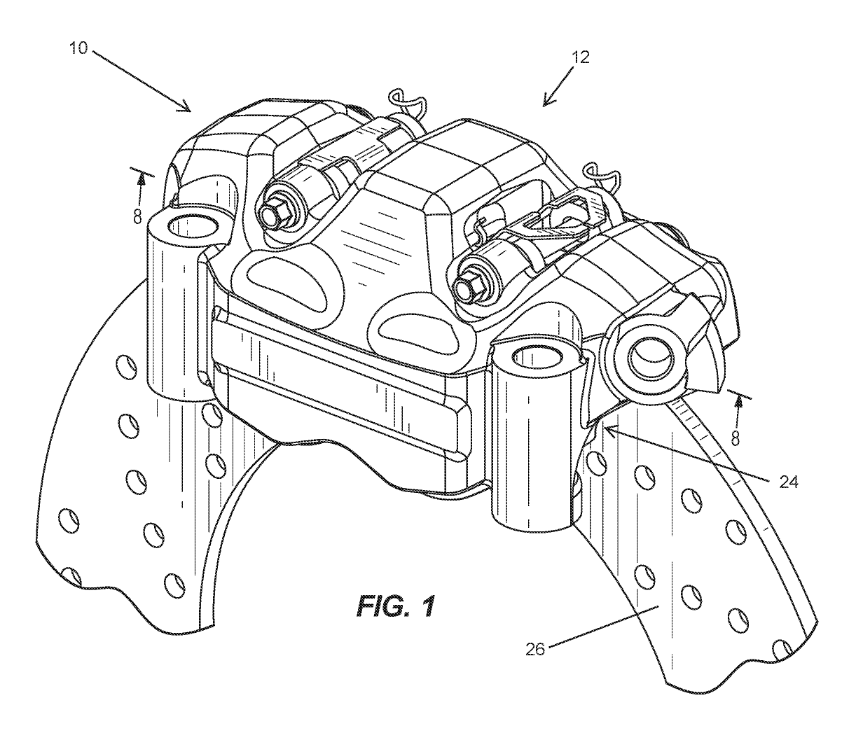

FIG. 1 illustrates a brake caliper assembly 10 including a caliper housing 12, inner and outer pad assemblies 14,16 positioned in the caliper housing 12, and an anti-rattle spring 18 that biases the pad assemblies 14,16 relative to the caliper housing 12.

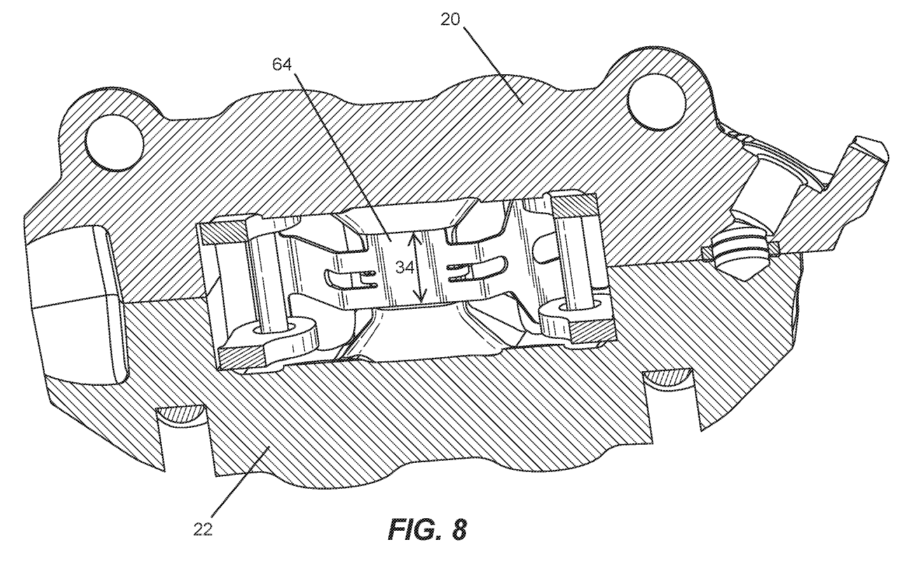

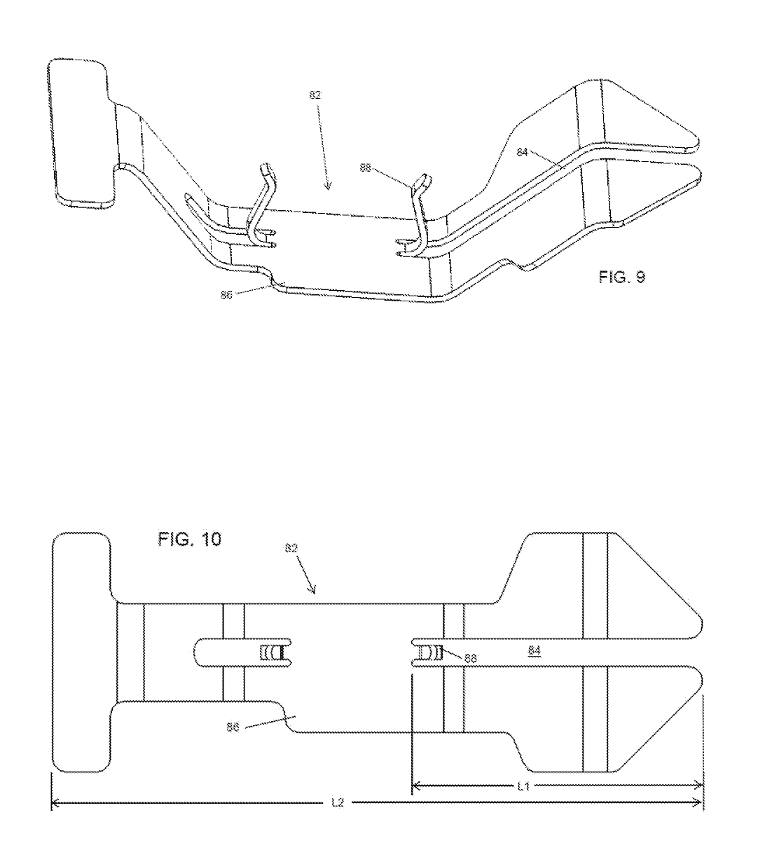

The caliper housing 12 includes an outer housing portion 20, an inner housing portion 22, and a disc recess 24 defined between the outer housing portion 20 and the inner housing portion 22. The disc recess 24 is adapted to receive a brake disc 26. Each of the inner and outer housing portions 20,22 includes a torque take-out surface 28 that engages the corresponding inner and outer pad assembly 14,16, respectively, during braking. The caliper housing 12 further includes a bridge 30 connecting the inner and outer housing portions 20,22 and substantially aligned with the disc recess 24. The bridge 30 includes notches 32 that facilitate attachment of the anti-rattle spring 18, as described below in more detail. Immediately below the bridge 30, the caliper housing 12 defines an asymmetrical space 34 (see FIG. 8) that is offset relative to a centerline 35 defined by the middle of the brake disc 26. The asymmetrical space 34 is designed to insure that the anti-rattle spring 18 is positioned in the correct orientation, as described below in more detail.

The inner and outer pad assemblies 14,16 are positioned substantially in the inner and outer housing portions 20,22, respectively, on opposing sides of the disc recess 24. Each pad assembly 14,16 is adapted to contact the corresponding torque take-out surface 28 on the inner and outer housing portions 20,22, respectively. Each illustrated pad assembly 14,16 includes two pads 38 mounted on a backplate 40. Each backplate 40 includes front and rear portions that are formed by front and rear hangers 42,44 including front and rear openings 46,48, respectively. Front and rear retention pins 50,52 are positioned through the outer housing portion 20, through the front and rear openings 46,48 of each pad assembly, and threaded into the inner housing portion 22 to support the pad assemblies 14,16 in the caliper housing 12.

The anti-rattle spring 18 includes a front section 54 biasing the front portions of the pad assemblies 14,16, a rear section 56 biasing the rear portions of the pad assemblies 14,16, and a central section 58 between the front and rear sections 54,56. The central section 58 is biased downwardly (i.e., toward the pad assemblies) by the bridge 30 of the caliper housing 12. The central section 58 of the anti-rattle spring 18 is attached to the bridge 30 by an attachment member in the form of spring clip having fingers 62 that are dimensioned to latch onto the bridge 30. Specifically, portions of the fingers 62 wrap around the end of the bridge 30 and are positioned in the notches 32 of the bridge 30 to retain the anti-rattle spring 18 on the bridge 30 in a releasable manner when the pad assemblies 14,16 are removed.

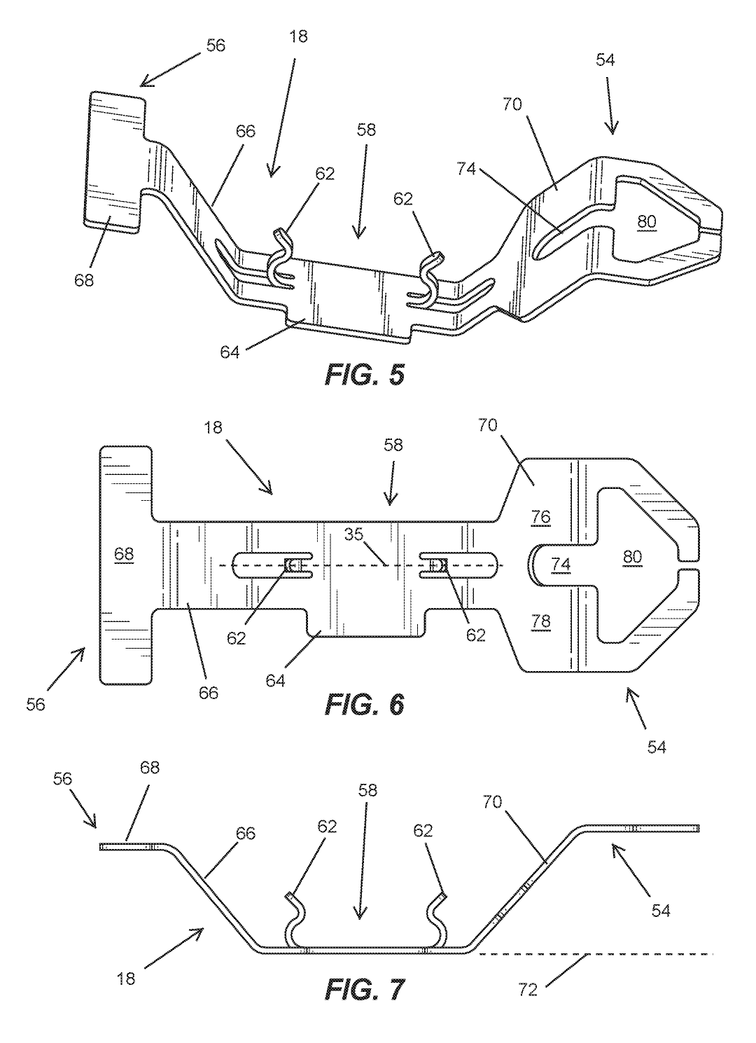

Referring to FIGS. 5-8, the central section 58 further includes an asymmetrical tab 64 that is dimensioned to fit into the asymmetrical space 34 defined by the caliper housing 12. If the anti-rattle spring 18 is inserted into the caliper housing 12 in an incorrect orientation, the asymmetrical tab 64 will not be properly oriented with the asymmetrical space 34, thus preventing the spring 18 from being attached to the bridge 30. This feature insures that the anti-rattle spring 18 can only be installed in the proper orientation.

As best shown in FIGS. 5-7, the rear section 56 of the anti-rattle spring 18 includes a neck portion 66 and a head portion 68. The neck portion 66 is positioned between and not engaged with the inner and outer pad assemblies 14,16. The head portion 68 is engaged with the top of the rear hangers 44 of the inner and outer pad assemblies 14,16 to bias the rear hangers 44 downward toward the disc recess 24, which is substantially parallel to the torque take-out surfaces 36 of the caliper housing 12. In other words, the illustrated rear section of the anti-rattle spring 18 does not provide a significant bias on the pad assemblies 14,16 toward or away from the torque take-out surfaces 36.

The front section 54 of the anti-rattle spring 18 includes an angled portion 70 that is wide enough to engage the front hangers 42 of both of the inner and outer pad assemblies 14,16. The illustrated angled portion 70 is positioned at an angle of about forty-five degrees relative to a tangent 72 to the brake disc 26 such that the biasing force provided by the front section 54 of the anti-rattle spring 18 on the front portions of the pad assemblies 14,16 tends to bias the pad assemblies 14,16 both downward toward the disc recess 24 and forward toward the torque take-out surfaces 36. In light of the forces provided by the front and rear sections 54,56 of the anti-rattle spring 18 on the pad assemblies 14,16, it can be seen that the net biasing force on the pad assemblies 14,16 is in the downward and forward directions.

As best shown in FIGS. 5-6, the front section of the anti-rattle spring 18 includes a slot 74 that divides the front section into inner and outer cantilevered parts 76,78 that engage the inner and outer pad assemblies 14,16, respectively. By virtue of the slotted arrangement, engagement of the inner cantilevered part 76 of the front section of the anti-rattle spring 18 with the inner pad assembly 14 is less dependent on the engagement of the outer cantilevered part 78 of the front section of the anti-rattle spring 18 on the outer pad assembly 16, and vice versa.

The front section also includes an arrow-shaped feature 80 that provides the installer with a visual indication of the front of the spring 18. The front of the spring 18 should go towards the front of the brake assembly, which is the direction of movement of the brake disc 26 through the caliper housing 12 when the vehicle is moving forward.

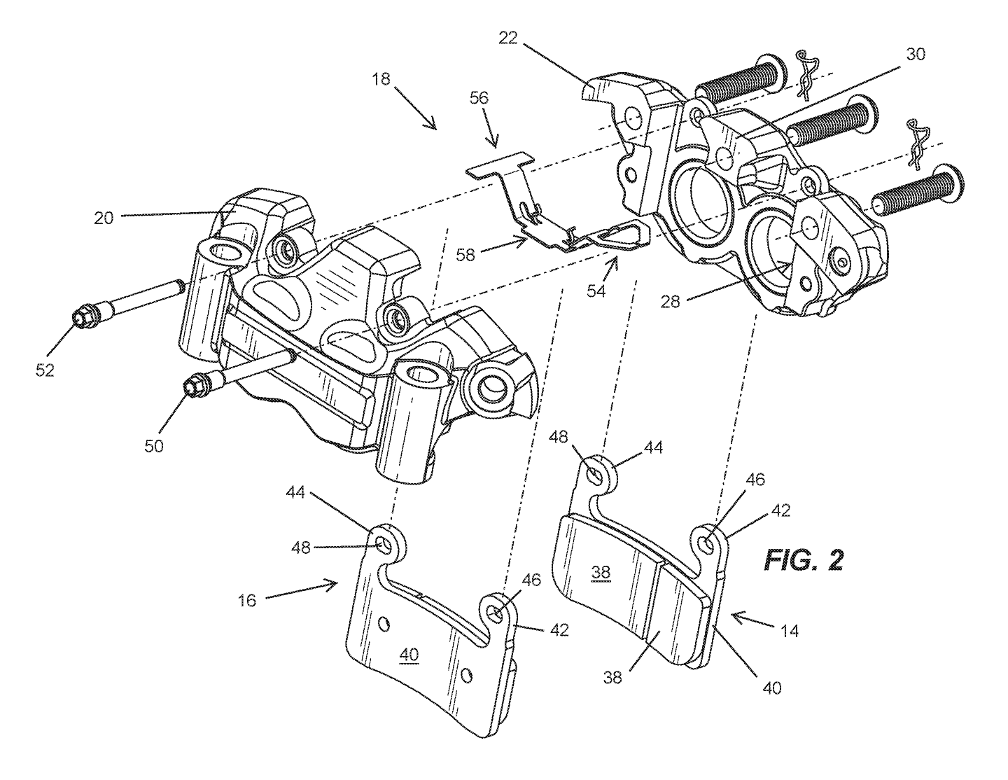

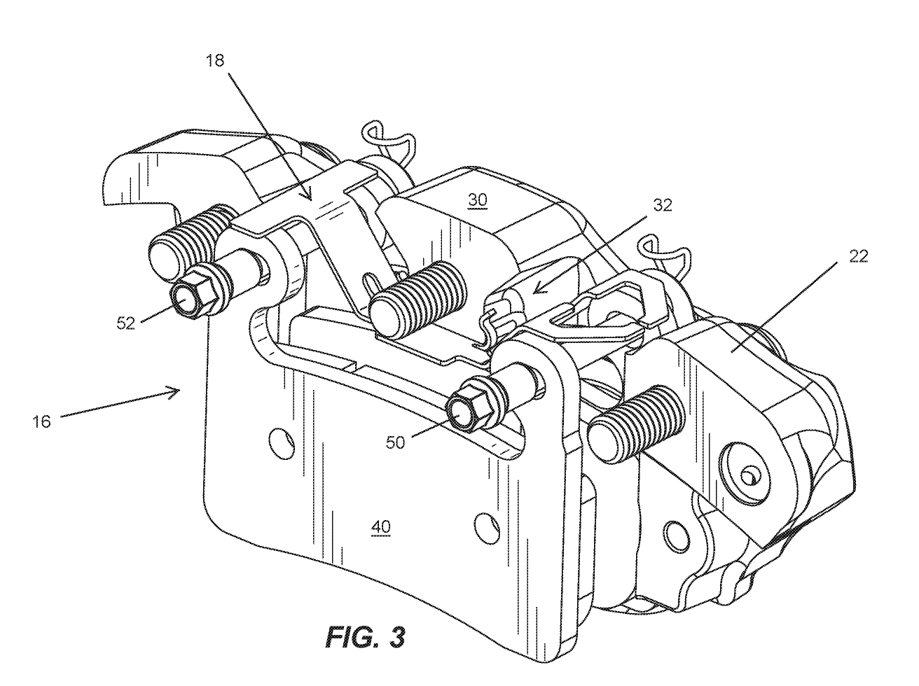

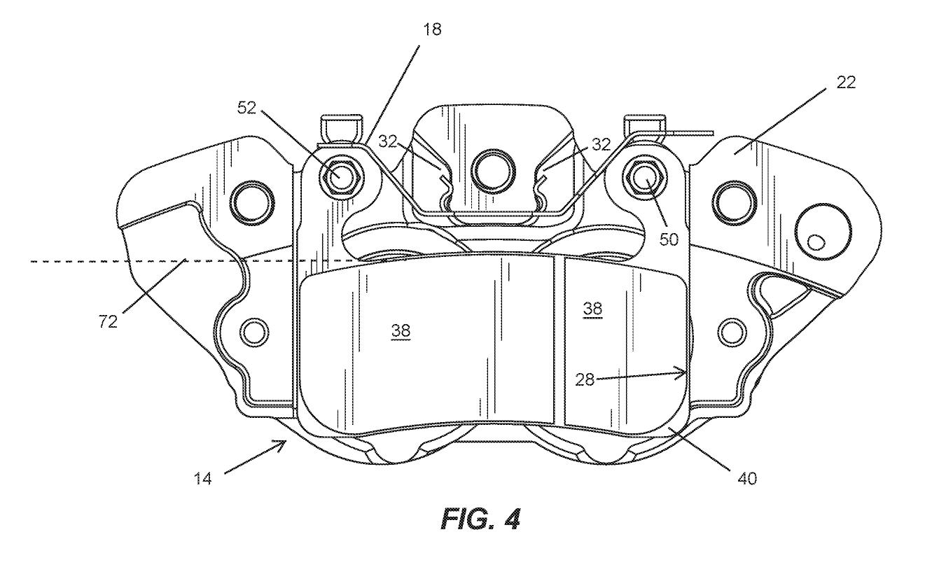

The anti-rattle spring 82 of FIGS. 9 and 10 represents a second embodiment of the present invention. The anti-rattle spring 82 is very similar to the spring shown in FIGS. 1-8, except for the slot 84 and the asymmetrical tab 86. The slot 84 differs from the previous embodiment in that it extends all the way to the nearest finger 88. In this regard, the slot 84 has a length L1 that is about 45% of the total length L2 of the spring 82. The asymmetrical tab 86 has a slightly different size and shape compared to the tab of the previous embodiment, but otherwise performs the same function of preventing the insertion of the spring 82 in an incorrect orientation.

Various features and advantages of the invention are set forth in the following claims.

1. A brake caliper assembly comprising:
a caliper housing including:
an outer housing portion;
an inner housing portion;
a recess defined between the outer housing portion and the inner housing portion, the recess adapted to receive a brake disc;
a torque take-out surface; and
a bridge substantially aligned with the recess;
a pad assembly positioned in the caliper housing adjacent the recess and adapted to contact the torque take-out surface; and
an anti-rattle spring including:
a front section biasing the pad assembly;
a rear section biasing the pad assembly; and
a central section between the front and rear sections, the central section being biased toward the pad assembly by the bridge of the caliper housing, the central section of the spring being attached to the bridge such that the spring stays attached to the bridge when the pad assembly is removed from the caliper housing.

2. A brake caliper assembly as claimed in claim 1, wherein the bridge couples the outer housing portion with the inner housing portion.

3. A brake caliper assembly as claimed in claim 1, wherein the pad assembly comprises an inner pad assembly positioned in the inner housing portion, wherein the torque take-out surface comprises an inner torque take-out surface defined in the inner housing portion, wherein the brake caliper assembly further includes:
an outer pad assembly positioned in the outer housing portion; and
an outer torque take-out surface defined in the outer housing portion and adapted to contact the outer pad assembly,
wherein each of the inner and outer pad assemblies includes a front portion and a rear portion that are biased by the front section and rear section of the spring, respectively.

4. A brake caliper assembly as claimed in claim 3, wherein the rear section of the anti-rattle spring comprises:
a neck portion positioned between and not engaged with the rear portions of the inner and outer pad assemblies; and
a head portion engaged with the rear portions of the inner and outer pad assemblies.

5. A brake caliper assembly as claimed in claim 3, wherein the front section of the anti-rattle spring includes a slot substantially parallel to the recess and dividing the front section of the anti-rattle spring into inner and outer parts that separately engage the inner and outer pad assemblies, respectively.

6. A brake caliper assembly as claimed in claim 5, wherein the inner and outer parts are cantilevered to provide at least partially independent forces on the inner and outer pad assemblies, respectively.

7. A brake caliper assembly as claimed in claim 3, wherein the anti-rattle spring biases the front portions of the inner and outer pad assemblies in a forward direction such that the inner and outer pad assemblies contact the inner and outer torque take-out surfaces, respectively.

8. A brake caliper assembly as claimed in claim 7, wherein the anti-rattle spring biases the rear portions of the inner and outer pad assemblies in a direction substantially parallel to the torque take-out surfaces.

9. A brake caliper assembly as claimed in claim 1, wherein the anti-rattle spring is attached to the bridge by a spring clip that facilitates removable attachment of the anti-rattle spring to the bridge.

10. A brake caliper assembly as claimed in claim 9, wherein the spring clip comprises resilient fingers that engage opposing surfaces of the bridge.

11. A brake caliper assembly as claimed in claim 10, wherein the bridge comprises opposing notches that receive the resilient fingers.

12. A brake caliper assembly as claimed in claim 1, wherein the anti-rattle spring further includes an alignment feature that insures proper orientation of the anti-rattle spring relative to the caliper housing.

13. A brake caliper assembly as claimed in claim 12, wherein the alignment feature comprises an asymmetrical tab and wherein the caliper housing includes an asymmetrical space adapted to receive the asymmetrical tab.

14. A brake caliper assembly comprising:
a caliper housing including:
an outer housing portion;
an inner housing portion;
a recess defined between the outer housing portion and the inner housing portion, the recess adapted to receive a brake disc;
a torque take-out surface adjacent a forward end of the recess; and
a bridge substantially aligned with the recess;
a pad assembly positioned in the caliper housing adjacent the recess and adapted to contact the torque take-out surface, the pad assembly including a front portion and a rear portion; and
an anti-rattle spring including:
a front section toward the torque take-out surface;
a rear section opposite to the front section; and
a central section between the front and rear sections, the central section being biased toward the pad assembly by the bridge of the caliper housing,
wherein the front section contacts the front portion of the pad assembly to bias the pad assembly toward the torque take-out surface.

15. A brake caliper assembly as claimed in claim 14, wherein the pad assembly comprises an inner pad assembly positioned in the inner housing portion, wherein the torque take-out surface comprises an inner torque take-out surface defined in the inner housing portion, wherein the brake caliper assembly further includes:
an outer pad assembly positioned in the outer housing portion and including a front portion and a rear portion; and
an outer torque take-out surface defined in the outer housing portion and adapted to contact the outer pad assembly,
wherein the rear section of the anti-rattle spring comprises:
a neck portion not engaged with the rear portions of the inner and outer pad assemblies; and
a head portion engaged with the rear portions of the inner and outer pad assemblies.

16. A brake caliper assembly as claimed in claim 15, wherein the anti-rattle spring biases the front portions of the inner and outer pad assemblies in a forward direction such that the inner and outer pad assemblies contact the inner and outer torque take-out surfaces, respectively.

17. A brake caliper assembly as claimed in claim 16, wherein the anti-rattle spring biases the rear portions of the inner and outer pad assemblies in a direction substantially parallel to the torque take-out surfaces.

18. A brake caliper assembly as claimed in claim 14, wherein the central section of the spring is attached to the bridge such that the spring stays attached to the bridge when the pad assembly is removed from the caliper housing.

19. A brake caliper assembly as claimed in claim 18, wherein the anti-rattle spring is attached to the bridge by a spring clip that facilitates removable attachment of the anti-rattle spring to the bridge.

20. A brake caliper assembly as claimed in claim 14, wherein the anti-rattle spring further includes an alignment feature that insures proper orientation of the anti-rattle spring relative to the caliper housing.
